(19) United States
(12) Patent Application Publication
(10) Pub. No.: US 2015/0220694 A1
(43) Pub. Date: Aug. 6, 2015

(54) HEADACHE DISEASE MANAGEMENT SYSTEM AND METHOD

(71) Applicants: Bruce P. Abbott, Dartmouth, MA (US); John W. Burns, Marion, MA (US)

(72) Inventors: Bruce P. Abbott, Dartmouth, MA (US); John W. Burns, Marion, MA (US)

(21) Appl. No.: 14/612,375

(22) Filed: Feb. 3, 2015

Related U.S. Application Data
(60) Provisional application No. 61/935,094, filed on Feb. 3, 2014.

(51) Int. Cl. G06F 19/00

(52) U.S. Cl. CPC G06F 19/345; G06F 19/3487; G06F 19/363

(57) ABSTRACT

A method of diagnosing and treating headaches is disclosed. The method includes using a computer server having diagnostic software tool thereon operative to collect a plurality of information from a patient. The method includes collecting detailed medical symptoms information from a patient of the patient's headaches via the computer server and diagnostic tool. The information is analyzed and a report is created of headache conditions and comorbidities. The report is transmitted to a health care provider who reviews the report to determine an optimal treatment plan for the patient. The health care provider creates a treatment plan for the patient based on the report.

### CROSS-REFERENCE TO RELATED APPLICATION

This patent document claims priority to earlier filed U.S. Provisional Patent Application No. 61/935,094, filed on Feb. 3, 2014, the entire contents of which are incorporated herein by reference.

### BACKGROUND

1. Technical Field

The present patent document relates generally diagnosing headaches and migraines in patients and more specifically to a diagnostic system for identifying headaches and migraine sufferers and underlying causes of the disease.

2. Background of the Related Art

Headache disease management is medically relevant because: (1) headache is the number one complaint for which patients seek medical advice; (2) there are 46 million chronic headache suffers in the US and over 700 million worldwide; (3) lost days to headache account for billions of dollars yearly; (4) no other headache management tool exists; and (5) primary care doctors and mid-level providers who treat 94% of chronic headache suffers have on average 7 minutes per visit to assess and manage the over 30 frequent causes of chronic headache. Results are often unsatisfactory.

Headache experts agree that a detailed question-and-answer session with a patient can often produce enough information for a diagnosis. However, the patient needs to interact with a qualified headache expert and the “Twenty Questions” involves many more questions than “20”. And the interview requires more than the 8 to 10 minutes a primary care physician can spend with a patient.

Therefore, there is a perceived need in the industry for an efficient method of diagnosing headaches that does not require trained or certified experts to utilize and may be administered rapidly.

### SUMMARY

The present invention solves the problems of the prior art by providing systems to acquire critical clinical data, diagnose headache types and relevant comorbidities. These result in treatment pathways which can be offered by non-expert primary care physicians and mid-level providers such as NP's and PA's.

The system uses computer based technology to outsource information acquisition to the patient before the physician encounter, then uses algorithms to analyze the data to diagnose up to 26 headache types and comorbidities. This information is codified into an individual treatment plan that can be implemented by primary care doctors or mid-level providers at the time of the first medical visit.

The primary benefit of the system is that chronic headache frequency, pain intensity and work and personal disability can be reduced.

The system provides further benefits to the patient, such as: (1) personal satisfaction due to symptom reduction; (2) less time disabled from work and personal activities; and (3) less cost to diagnose and manage the chronic disease of headache

The system also decreases the cost of diagnosing and treating headaches by requiring or limiting (1) fewer imaging studies—CT and MRI brain; (2) lower pharmaceutical expenditure (3) fewer physician office visits, ER visits and hospitalizations.

### BRIEF DESCRIPTION OF THE DRAWINGS

These and other features, aspects, and advantages of the present invention will become better understood with reference to the following description, appended claims, and accompanying drawings where:

FIG. 1 is a flow chart illustrating the steps of diagnosing and treating a headache in the system;

FIG. 2A shows an illustration of a computer server having software operative for a preferred embodiment of the system for diagnosing and treating headaches;

FIG. 2B sows an illustration of a system operative for a preferred embodiment of the system for diagnosing and treating headaches;

FIG. 3 shows a flow chart illustrating the steps of obtaining diagnostic information from a patient for a preferred embodiment of the system for diagnosing and treating headaches;

FIG. 4 shows an illustration of an exemplary report summarizing the diagnostic results of the patient;

FIG. 5 shows an illustration of an exemplary report showing a detailed analysis of the patient; and

FIG. 6 shows an illustration of an exemplary report showing treatment priorities of the patient.

### DESCRIPTION OF THE PREFERRED EMBODIMENT

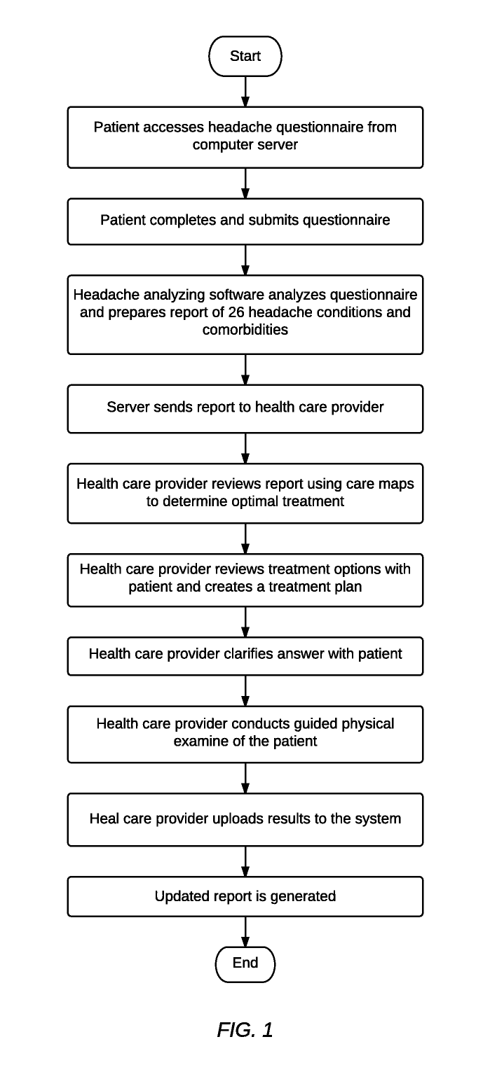

Referring now to FIG. 1, a first embodiment of the method and system is shown generally. The patient accesses and completes the detailed diagnostic questionnaire. The diagnostic questionnaire, and subsequent patient responses, is stored on a computer server. Software on the computer server analyzes the patient response and generates of the twenty-six headache conditions and comorbidities. The report is transmitted to the medical professional. The medical professional reviews the report and selects a treatment option (i.e. care map) for the patient. The care maps are also generated by the computer server. The medical professional then reviews the treatment options with the patient and creates a treatment plan. Each of these steps will be described further below.

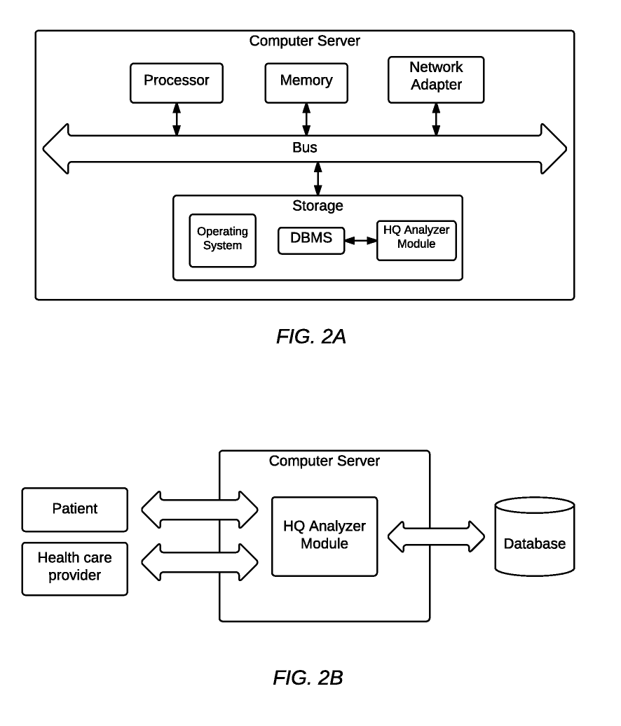

Generally shown in FIG. 2A, the system includes a computer server with a database thereon. The computer server may be a general purpose computer having central processing unit, random access memory, a storage device (such as a hard disc, array of hard discs, solid state storage device and the like) with an operating system. No particular operating system or database management system is required. One skilled in the art would be able to implement the system described herein on any computer hardware and software. Furthermore, although the discussion below is made with reference to a single computer server, multiple computer servers may be used. For instance, the diagnostic questionnaire may be collected on one server with patient responses stored in a database operating on another computer server. Patients and medical providers may access the computer server through an internet or wirelessly connected device, such as a tablet computer, personal computer, laptop computer and the like, and even a smart phone.

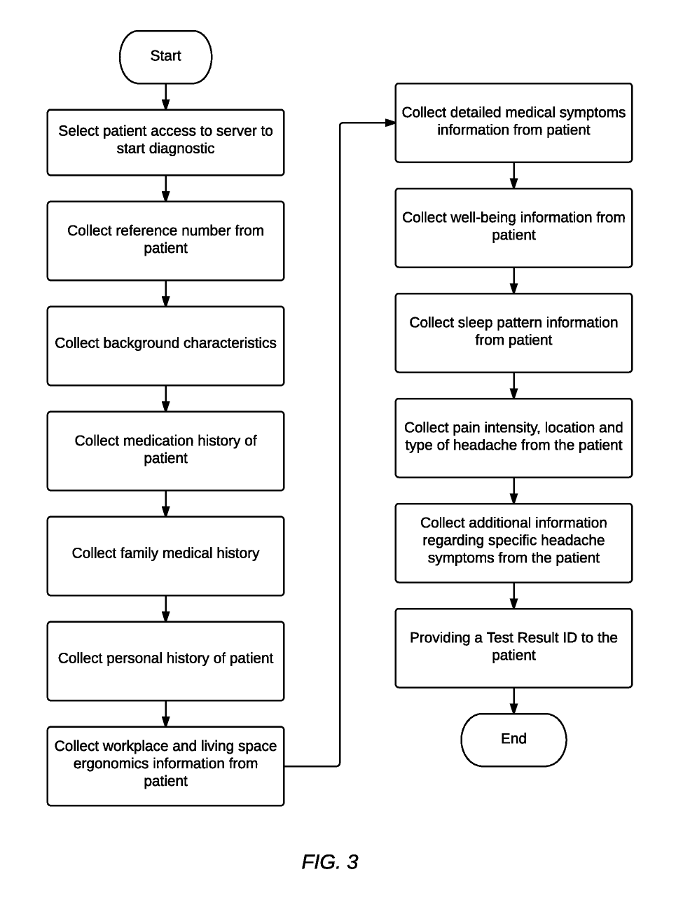

Referring to FIGS. 2B and 3, the system includes an HA Analyzer module, running on the computer server, which collects answers to a detailed diagnostic questionnaire from the patient information using the internet or wirelessly connected device, such as a tablet computer. The diagnostic questionnaire includes many questions that the patient answers concerning their background, medical condition, medical history and personal characteristics. The questions progressively build on one another and are based in part on previously answered questions. The diagnostic questionnaire includes male and female specific questions as well as other characteristics of the patient. The patient's answers are analyzed by the HA Analyzer module and an analysis (or report) is returned to the medical provider, all before the patient has even met the medical provider. The questionnaire may be completed at the patient's home or at the medical professional's office in the waiting room. Logic branching tailors questions to the patient profile and medical conditions. Based on early patient responses, the HR Analyzer is designed to drill down for further exploration of possible conditions and comorbidities. Treatment of the comorbidities is critical to the successful treatment of the headache.

Once the medical provider meets with the patient, the medical provider reviews the report with the patient. During this review, the medical provider has access to the patient's answer and the report generated by the HR Analyzer. The medical professional clarifies ambiguous answers to the question or any other patient answers. The medical professional also conducts a brief physical exam on the patient, guided by the answers the patient has given. The computer server via the internet or wirelessly connected device will provide prompts for a guided physical exam based on the patient's answers. The medical professional uploads the results to the system using the connected device, where the results are processed and an updated report is generated.

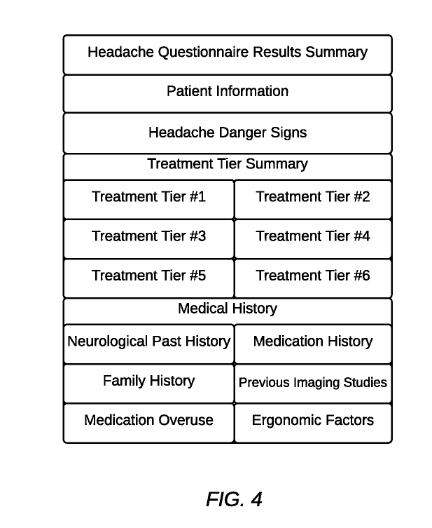

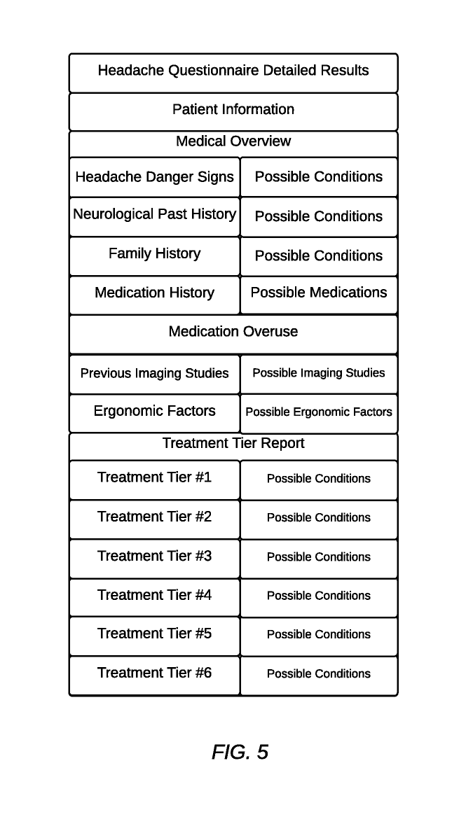

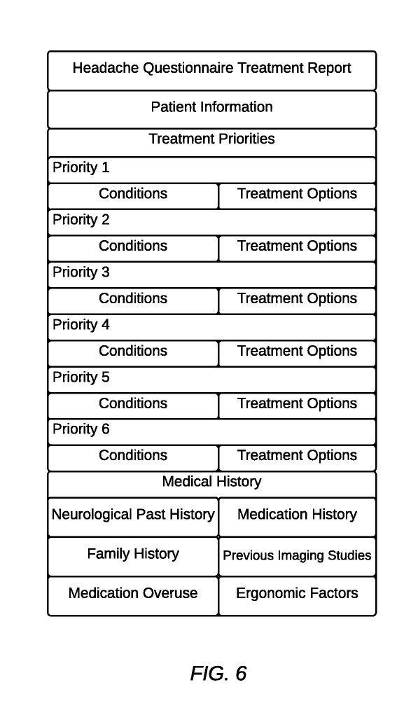

The report generated by the computer server is a multi-faceted report that includes a summary (FIG. 4) of the analysis and a detailed analysis (FIG. 5) and a third report detailing the treatment tiers (FIG. 6). The summary analysis includes several sections including a summary of findings that identifies danger signs and conditions requiring immediate treatment and treatment tiers based on medical evidences hierarchy ordered in preferred treatment. The detailed analysis provides an ordered breakdown of actual medical conditions exhibited by the patient and other possible medical conditions requiring further diagnoses. The actual versus possible medical conditions may be ordered in a drill down analysis that compares the patient responses for the symptoms or indicators for the actual versus possible medical conditions. The detailed analysis of the patient's responses to the diagnostic further includes neurological past history, family history, medication history, identification of possible medication overuse, past imaging studies and a detailed discussion of the treatment tiers recommended for the patient. The treatment tiers are organized in six tiers ordered by hierarchy of preferred treatment sequence. The treatment tiers further display evidenced based treatment methods for each tier of the sequence.

Based on the results of the updated report, a selection of treatment options are provided to the medical professional, who prescribes a treatment option for the patient, generally in the preferred order presented in the treatment tiers. That is, Treatment Tier 1 is prioritized over Treatment Tier 2, etc. An order set is generated for the patient, which may include such treatments as medication overuse withdrawal, lifestyle modification, dietary modification ergonomic management (e.g. seating posture), physical therapy, macromastia surgery for females, pain management, psychological counseling, dental treatment and appliances, sleep study, imaging studies, and prescription medications. The patient may be provided education materials covering one or more the treatment options and diagnosed medical conditions and a headache log, for tracking occurrences of headaches for review during a follow-up appointment. The order set is further stored at the database on the computer server. A patient may be tracked from beginning to end of treatment with the system.

The system described herein identifies and provides treatment options for headache sufferers that presently go undiagnosed. By identifying, prioritizing and treating conditions and the associated comorbidities, health care providers are able to treat headaches in patients that have multiple, complex causes and headaches that are not readily apparent to the primary care physician when examining a headache patient.

Chronic headache sufferers experience multiple headache types and comorbidities and frequently many of these must be treated before the primary acting headache can be successfully dealt with. For example, medication overuse headache (MOC) presents a non-starter for the treatment of migraine. MOC must first be successfully treated before migraine headache can be resolved. Likewise, a patient experiencing restless leg syndrome will not be successfully treated until this condition is brought under control. Restless leg syndrome interferes with restful sleep, a key condition that must be present for successful headache treatment.

No other headache tool provides the comprehensive diagnosis and analysis of patient headache. Combined with the treatment tier approach provided in the headache report and the detailed pathways for treatment offered the physician in the treatment maps, the Headache Analyzer is a unique tool available for the primary care physician and mid-level practitioners.

Therefore, it can be seen that the system described herein provides a novel and efficient method of identifying and treating headaches in patients that can be administered by non-specialist medical professionals at reduced cost for both patients and the medical system.

It would be appreciated by those skilled in the art that various changes and modifications can be made to the illustrated embodiments without departing from the spirit of the present invention. All such modifications and changes are intended to be within the scope of the present invention.

What is claimed is:

1. A method of diagnosing and treating headaches, comprising a computer server having diagnostic software tool thereon operative to collect a plurality of information from a patient, the method comprising:
collecting detailed medical symptoms information from a patient of the patient's headaches via the computer server and diagnostic tool;
analyzing the answers from the patient via the computer server and diagnostic tool;
creating a report of headache conditions and comorbidities based on the detailed medical symptoms information collected from the patient via the computer server and diagnostic tool;
transmitting the report to a health care provider via the computer server and diagnostic tool;
reviewing the report to determine an optimal treatment plan for the patient; and
creating a treatment plan for the patient based on the report.

2. The method of claim 1, further comprising collecting a reference number from the patient.

3. The method of claim 1, further comprising collecting background characteristics of the patient.

4. The method of claim 1, further comprising collecting family medical history from the patient.

5. The method of claim 1, further comprising collecting personal history of the patient.

6. The method of claim 1, further comprising collecting workplace and living space ergonomics information from a patient.

7. The method of claim 1, further comprising collecting well-being information from the patient.

8. The method of claim 1, further comprising collecting sleep patent information from the patient.

9. The method of claim 1, further comprising collecting pain intensity, location and type of headache from the patient.

10. The method of claim 1, further comprising collecting additional information regarding specific headache symptoms from the patient.

11. The method of claim 1, further comprising providing a Test Result ID to the patient.

12. The method of claim 1, wherein the report includes possible headache conditions of the patient and treatment options therefore.

13. The method of claim 12, wherein the headache conditions are organized into six treatment tiers.

14. The method of claim 12, wherein the headache conditions are organized into six treatment priorities.

15. The method of claim 1, wherein the report includes a report summary, a detailed medical overview, and a treatment priorities sections.

16. The method of claim 1, wherein the software diagnostic tool is operative to collect sex-specific information from the patient.

17. The method of claim 1, further comprising clarifying answers to information collected from the patient.

18. The method of claim 1, further comprising conducting a guided physical exam on the patient based on the report.

19. The method of claim 17, further comprising updating the collected information from the patient and generating an updated report.

20. The method of claim 18, further comprising updating the collected information from the patient and generating an updated report.
